(19) United States
(12) Patent Application Publication
(10) Pub. No.: US 2016/0005434 A1
(43) Pub. Date: Jan. 7, 2016

(54) WRITING DATA TO A TAPE

(71) Applicant: HEWLETT-PACKARD DEVELOPMENT COMPANY, L.P., Houston, TX (US)

(72) Inventors: Jonathan Peter Buckingham, Bristol (GB); Rafel Jibry, Bristol (GB)

(21) Appl. No.: 14/442,450

(22) PCT Filed: Jan. 30, 2013
(86) PCT No.: PCT/US13/23944

§ 371 Date: May 13, 2015

(51) Int. Cl. G11B 20/12; G11B 5/008

(52) U.S. Cl. CPC G11B 20/1202; G11B 5/00817

(57) ABSTRACT

A method of writing data to a tape on which during a write operation successive data unit groups that comprise a plurality N of data units are written across the tape as N track portions to form N data tracks that extend in a lengthways direction of the tape. The method includes identifying data units written during the write operation that need to be rewritten and writing a rewrite data unit group that contains data units identified as needing to be rewritten. The rewrite data unit group has N track portions written across the tape to form a part of the data tracks. The N track portions contain N-n data units identified as needing to be rewritten and data unit identifier information comprising respective data unit identifiers for the N-n data units contained in at least one list of data unit identifiers. N and n are positive integers.

### BACKGROUND

Tape drives may store multiple tracks of data onto a tape simultaneously. For example, tape drives that use the linear tape open (LTO) specification may write sixteen or thirty two tracks of data onto the tape at the same time. Many tape drives are configured with read heads positioned adjacent to or behind the write heads. This allows the tape drive to read the data from the tape as it is being written onto the tape. This feature is typically called read-while-write. Using the read-while-write feature a tape drive can immediately detect errors in what has been written onto the tape. When an error is detected using the read-while-write feature, the data can be re-written to a different location on the tape. This may involve writing all sixteen or thirty two tracks of data onto the tape even when only one track of the originally written tracks had errors.

### BRIEF DESCRIPTION OF THE DRAWINGS

In the disclosure that follows reference will be made to the drawings in which:

FIG. 1 is schematic illustration of an example of a tape drive and a tape to which data is written;

FIG. 2 is a schematic illustration showing data unit groups written by a tape drive such as the tape drive of FIG. 1;

FIG. 3 is a schematic illustration of an example of a data unit of a data unit group such as the data unit groups shown in FIG. 2;

FIG. 4 is a schematic illustration of an example of a header of the data unit of a FIG. 3;

FIG. 5 is a schematic illustration of an example of a data unit identifier of the header of FIG. 4;

FIG. 6 is a schematic illustration of an example of a rewrite data unit group;

FIG. 7 is a schematic illustration of another example of a rewrite data unit group;

FIG. 8 is a schematic illustration of a further example of a rewrite data unit group; and

FIG. 9 is a flow chart illustrating an example of writing data to a tape.

### DETAILED DESCRIPTION

In example implementations described below a tape drive writes data to a tape during a write operation by writing successive data unit groups that each comprise a plurality N of data units written across the tape in respective track portions that form N data tracks that extend in a lengthways direction of the tape. The tape drive identifies defective data units, or track portions, written during the write operation that will need to be rewritten. Instead of rewriting a complete data unit group that contains a data unit(s) identified as needing to be rewritten, tape drive rewrites such data units in a rewrite data unit group that contains an accumulation of data units identified as needing to be rewritten. Tape drive writes a rewrite data unit group as N track portions across the tape that form parts of the respective data tracks. The N track portions of the rewrite data unit group contain N-n data units identified as needing to be rewritten, where n is a positive integer value, and data unit identifier information comprising respective data unit identifiers for the N-n data units. The data unit identifier information is contained in one or more identifier information units that each contains a list of data unit identifiers. In some examples, the list in an identifier information unit contains the respective data unit identifiers of each of the N-n data units in a rewrite data unit group. In other examples, there may be two or more identifier information units that contain different lists of data unit identifiers configured so that a complete list of the respective data unit identifiers for each of the N-n data units in a rewrite data unit group is split between multiple identifier information units provided in a rewrite data unit group.

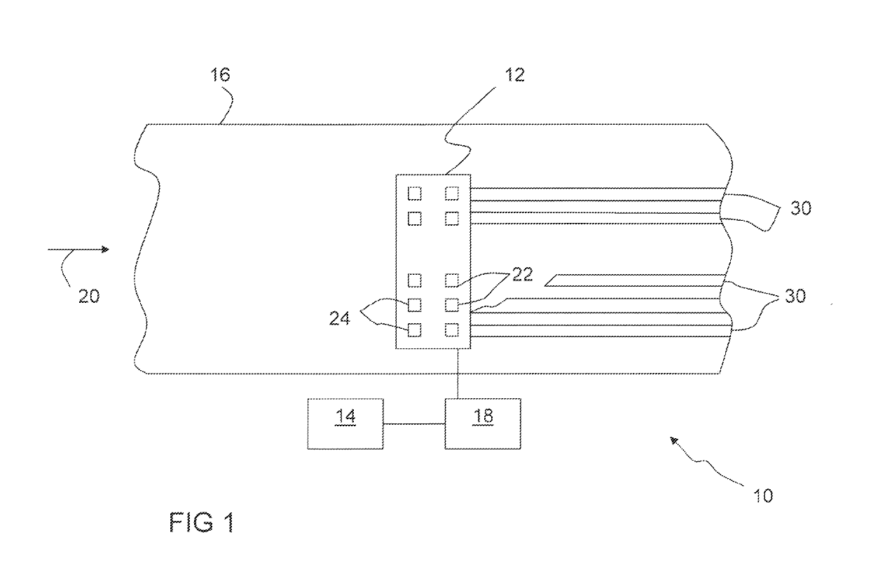

Referring to FIG. 1, an example of a tape drive 10 comprises a tape read/write head 12, a transport 14 to move a tape 16 past the read/write head and logic 18. In the illustrated example, the tape 16 moves in the direction of arrow 20. Read/write head 12 comprises a plurality of read heads 22 and a corresponding number of write heads 24. The plurality of read heads 22 may be positioned adjacent the plurality of write heads 24 to enable read-while-write functionality. In some examples, read/write head 12 may be positioned in multiple locations across the width of tape 16. In some examples, the functionality of the read heads 22 and write heads 24 may be swapped when the tape 16 switches directions. Logic 18 is coupled to tape read/write head 12 and is configured to monitor and control the data being written by read/write head. Logic 18 may comprise a processor, memory, an application specific integrated circuit (ASIC), a combination of processors, memory and ASICs, or the like.

In operation, tape drive 10 at least substantially simultaneously writes a set of N data track portions across tape 16. Successive sets of N data track portions written across tape 16 form data tracks 30 that extend in a lengthways direction of tape 16. Data tracks 30 may extend parallel to the longitudinal axis of tape 16. N is a positive integer greater than one and is typically an even number, for example eight, sixteen or thirty two. In some instances N may be an odd number, for example nine. In some examples, tape drive 10 may be configured so that all of the data tracks written onto a tape are written in a single pass. In other examples, tape drive may be configured to write a first plurality N of data tracks during a first pass and one or more further pluralities N of data tracks during one or more subsequent passes following lateral shifting of read/write head 12 relative to tape 16. For example, tape drive 10 may write eight of sixteen data tracks 30 in a first pass and the remaining eight or sixteen in a second pass. In one example, tape 16 is moved in the direction indicated by arrow 20 during a first pass and in the opposite direction during a second pass.

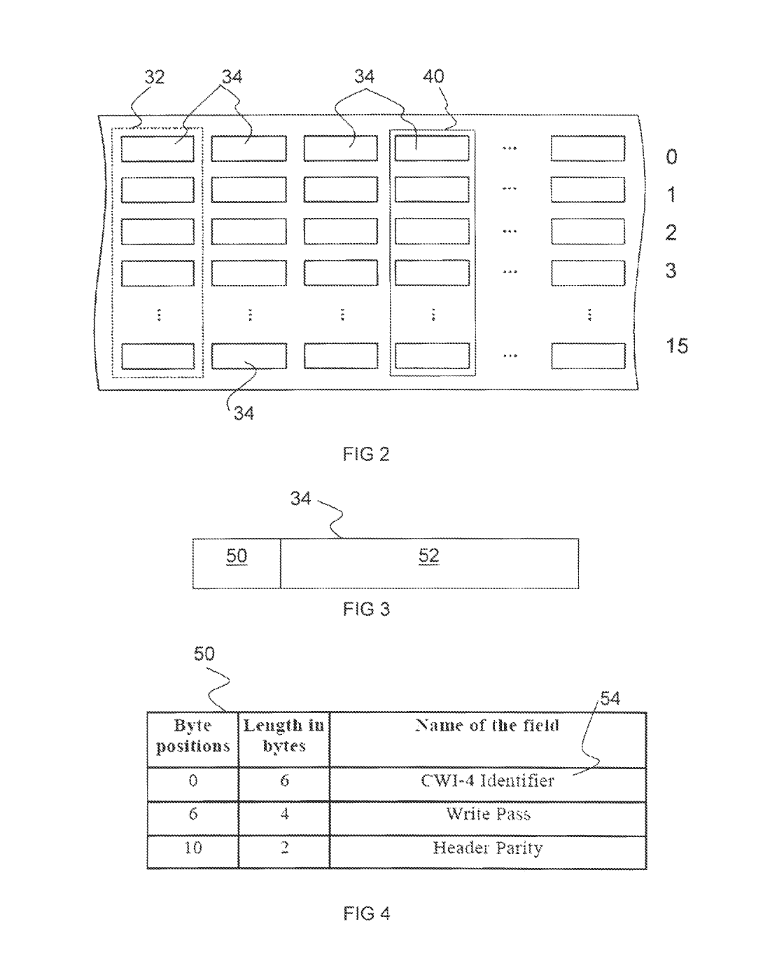

Referring to FIG. 2, tape drive 10 writes data onto the tape 16 in minimum sized chunks called data sets. Each data set is sub-divided into data unit groups 32. Each data unit group 32 contains N data units 34. Respective data units 34 are assigned to the data track portions so that the when a data unit group is written, the data units are written to respective data tracks 30. There may be ten data unit groups 32 for each data set. In the examples described with reference to FIG. 2 and FIGS. 6 to 8, N is equal to sixteen and the tracks and track portions illustrated by those Figures are numbered 0-15. The data units 34 may be code word interleaves (CWI) so that data unit groups 32 are CWI sets configured according a LTO standard. During a write operation, read/write head 12 writes the data units 34 of a data unit group 32 across tape 16 at least substantially simultaneously and successive data unit groups 32 are written by the read/write head to form data tracks 30. As a data unit group 32 is written to tape 16 by write heads 24, tape drive 10 uses read heads 22 to confirm that data units 34 have been written correctly. When one or more data units 34 in data unit groups 32 are identified as being defective, tape drive 10 rewrites the defective data units to tape 16 in rewrite data unit groups as described below.

Referring to FIG. 3, each data unit 34 comprises a header 50 and a data portion 52. User data is written in data portion 52. Referring to FIG. 4, header 50 contains a data unit identifier 54, which in the illustrated example takes the form of a CWI identifier. Referring to FIG. 5, data unit identifier 54 contains a data unit designation 56, which in the illustrated example is a CWI designation. Header 50 is used to identify the data contained in data portion 52 and without the header, that data would be lost. Except for data unit designation 56, the other fields in each data unit header 50 in a data unit group 32 are the same. Data unit designations 56 in a data unit group 32 have a predetermined relationship, which may be in accordance with a standard, such as an LTO standard. Since data unit designations 56 are the only variable in the headers 50 of a data unit group 32, if a header 50 in a data unit group 32 is damaged, the content of the header can be reconstructed from an undamaged header using a technique known as cross channel interpolation.

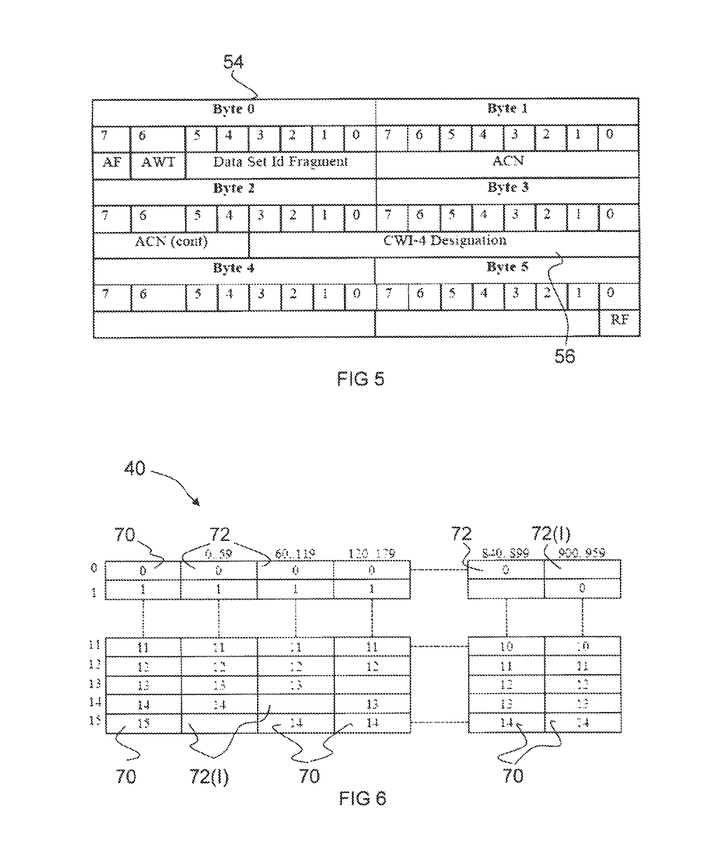

FIG. 6 is a schematic illustration of an example of a rewrite data unit group comprising N track portions that are written across the tape 16 in similar fashion to the track portions of the data unit groups 32. Since in the example illustrated by FIG. 2 data unit groups 32 have sixteen track portions, rewrite data unit group 40 also has sixteen track portions. The track portions of rewrite data unit group 40 are numbered 0 to 15 in the same way as the track portions of data unit groups 32.

Rewrite data unit group 40 contains N-n of the data units 34 that have been identified as being defective and needing to be rewritten. Thus there are fewer data units 34 written to a rewrite data unit group 40 than are written to a data unit group 32. In the illustrated example, N is sixteen and n is one so there are fifteen data units 34 written in rewrite data unit group 40. Rewrite data unit group 40 additionally contains data unit identifier information for the N-n data units it contains. In the illustrated example, the data unit identifier information comprises the respective data unit designations 56 for the N-n data units and is held in a list(s) provided in one or more identifier information units. In some examples a list may contain two copies of each data unit designation of the N-n data units. As described in more detail below, multiple copies of an identifier information unit may be written to multiple locations in rewrite data unit group 40.

The N track portions of rewrite data unit group 40 each have a header block, or space, 70 into which a header 50 can be written and N blocks, or spaces, 72 into which data from data portion 52 of a data unit 34 can be written. In the illustrated example, N is sixteen so there are sixteen track portions and each has sixteen blocks 72. Blocks 72 may each comprise sixty bytes as shown in FIG. 6. In FIG. 6, blocks 72 are identified by byte counts so that the block closest to the respective header block 70 is the 0-59 byte block and the block furthest from the header block is the 900-959 byte block. In an example in which thirty two tracks 30 are written to tape 16, rewrite data unit group 40 may comprise thirty two track portions that each has a header block 70 and thirty two blocks 72 that are thirty bytes long.

In rewrite data unit group 40, since there are N (sixteen) track portions and N-n (fifteen) data units 34 in the group, there is effectively a spare track portion, or space, comprising N blocks 72. Logic 18 configures rewrite data unit group 40 so that N-n (fifteen) of the track portions 0-14 contain the respective headers 50 of data units 34 in the respective header blocks 70 and data portions 54 of the data units are written into blocks 72 of all sixteen track portions 0-15 together with the identifier information units containing the data unit identifier information.

In the example illustrated by FIG. 6, the unit identifier information unit is written to one block (72(l) in each track portion 0-15 so that there are multiple instances of the identifier information unit in rewrite data unit group 40. The blocks 72(l) containing an identifier information unit are spaced apart in the lengthways direction of the track portions, or tape 16. In the particular example shown in FIG. 6, rewrite data unit group 40 is configured such that in a direction perpendicular to the lengthways direction of tape 16 no block 72(l) is aligned with another block 72(l). In order for each track portion 0-15 to contain a block 72(l), data from data portions 52 of the data units 34 may be split and distributed between a plurality of track portions. Thus, the blocks 72 of at least two track portions 0-15 may contain an identifier information unit and data from at least two data units 34.

In the example illustrated in FIG. 6, track portion 15 is not assigned a data unit 34 and data from the data portions 52 of the respective data units 34 assigned to tracks 0-14 is distributed between the track portions 0-15 by displacing blocks of data from each of data track portions 0-14 to an adjacent track. Specifically, at least one block of data from each of track portions 0-14 may be written to the next adjacent higher numbered track portion. The configuration is such that each track portion 0-14 has one or successive data blocks 72 disposed contiguously after the header block 70 containing data from the data portion 52 of the data unit 34 whose header 50 is written to the header block of the track portion. Data from a data unit that would have been written to a block 72(l) containing an identifier information unit or any block 72 downstream of the block 72(l) is written to the next adjacent higher numbered track portion. For example, track portion 1 has fourteen blocks 72 containing data from the data portion 52 of the data unit 34 whose header 50 is written into the header block 70 of the track portion disposed contiguously following the header block, followed by a block 72(l) containing an identifier information unit, which is followed by a block 72 containing data from the data portion 52 of the data unit 34 whose header 50 is written into the header block of track portion 0. Similarly, track portion 13 has two blocks 72 containing data from the data portion 52 of the data unit whose header 50 is written into the header block 70 of the track portion, followed by a block 72(l) containing an identifier information unit and then thirteen blocks 72 containing data from the data portion 52 of the data unit 34 whose header 50 is written into the header block 70 of track portion 12. As can be seen in FIG. 6, this arrangement results in a band of blocks 72(l) extending diagonally across the track portions 0-15 of the rewrite data unit group 40. In the illustrated example, the band of blocks 72(l) extends from the 0-59 byte block of track portion 15 to the byte 900 to 959 byte block of track portion 0. In another example, the rewrite data unit group 40 could be configured so that a band of blocks 72(l) extends from the 0-59 byte block of track portion 0 to the 900-959 byte block of track portion 15.

Because the data units 34 written into the rewrite data unit group 40 are rewrites of units previously written with errors, they will not have data unit designations 56 according with the predetermined relationship specified for data units in a data unit groups consisting of newly written data units. Accordingly, cross channel interpolation cannot be used to reconstruct damaged headers in data units contained in a rewrite data unit group. However, the provision of data unit designations 56 for each data unit in the rewrite data unit group 40 in the identifier information units contained in the blocks 72(l) makes it possible to determine the information content of a damaged header and thus user data associated with a damaged header can be found and will not be lost. For example, the data unit designation for a data unit can be looked up in the one of the identifier information units contained in a block 72(l) and the other header fields copied from any undamaged header in the rewrite data unit group.

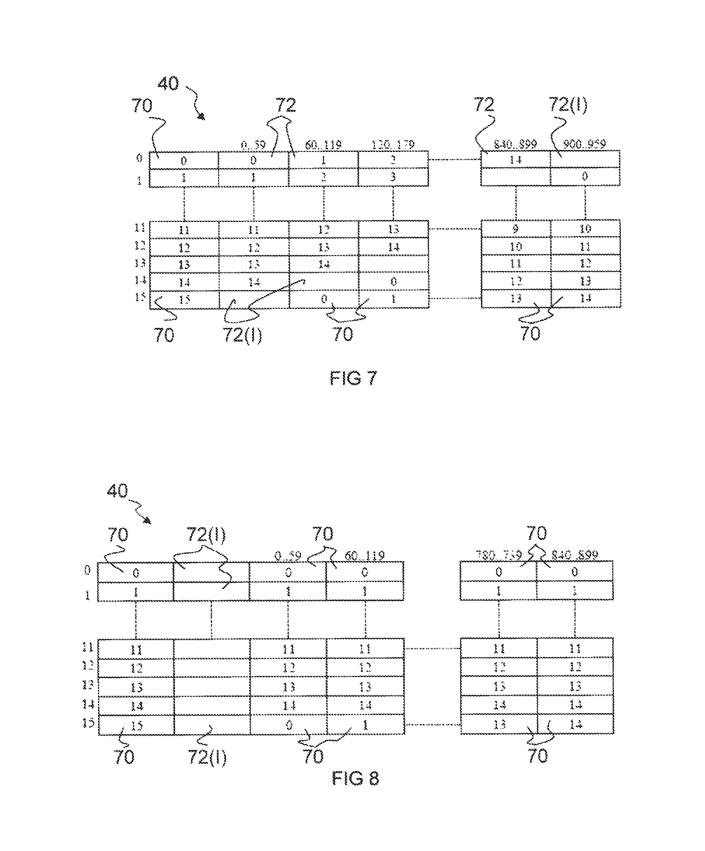

FIG. 7 illustrates another example of a rewrite data unit group 40. In this example, a band of blocks 72(l) containing respective identifier information units is provided in similar fashion to the rewrite data unit group shown in FIG. 6. However, the rearrangement of the data written into the remaining blocks 72 is different. In this example, the data written to the blocks 72 that do not contain an identifier information unit is more widely distributed. Each track portion 0-15 contains a block 72(l) containing an identifier information unit and respective blocks 72 containing data from each of the data units 34 written into the rewrite data unit group. In the particular example illustrated, the 0-59 byte block 72 of each of track portions 0-14 contains data from the data portion 52 of the data unit 34 whose header is written into the header block 70 of the track portion. The succeeding downstream blocks 72 in each track portion 0-14 contain data from respective higher numbered track portions 0-14. Thus, the 0-59 byte block 72 of track portion 0 contains data from the data portion 52 of the data unit 34 whose header 50 is written to header block 70 and the byte 60-119 to byte 840-899 blocks 72 respectively contain data from the data units whose header is written to the header blocks 70 of track portions 1-14. Similarly, in track portion 13, the byte 0-59 block 72 contains data from the data portion 52 of the data unit whose header 50 is written to the header block 70 of the track portion. The byte 60-119 block 72 contains data from the data portion 52 of the data unit 34 whose header 50 is written into the header block 70 of track portion 14 and is followed by a block 72(l) containing the data unit identifier information. Block 72(l) in track portion 13 is followed by successive blocks 72 containing data from the respective data portions 52 of the data units 34 whose headers 50 are written to the header blocks 70 of track portions 0-12. Track portion 15 has an identifier information unit in the byte 0-59 block and the following blocks contain data from the respective data portions 52 of each of the data units 34 in the rewrite data unit group. As can be seen in FIG. 7, the effect is that there are diagonally extending bands of blocks 72 containing data from the data portion 52 of the same data unit 34.

FIG. 8 illustrates another example of a data rewrite set 40. In this example, the blocks 72(l) containing an identifier information unit are the 0-59 byte block of each track portion 0-15 so that the blocks 72(l) are aligned across the width of tape 16. In order to accommodate a block 72(l) containing an identifier information unit in each of track portions 0-14, the data units 34 written into track portions 0-14 are each assigned one block 72 in track portion 15. In this arrangement the blocks 72(l) are at the same longitudinal position in the track portions 0-15 and as such may be more susceptible to damage than the blocks 72(l) of the arrangements shown in FIGS. 6 and 7 in which the blocks 72(l) are evenly distributed along the length of the track portions 0-15.

The data identifier information in blocks 72(l) may be validated by their own cyclic redundancy check (CRC) code. In a sixteen track rewrite data unit group with 960 bytes designated for blocks 72 of the respective track portions, there are sixteen 60 byte blocks per track. In order to generate sufficient unique data unit designations 56 for a data set comprising ten data unit groups 34, 12 bits may be allowed for a data unit designation. For fifteen data units 34 in a sixteen track rewrite data unit group, that provides a requirement of 15×12 bits (23 bytes). Thus, even with CRC protection included in the blocks 72(l) it is possible to have a list containing two copies of the respective data unit designations 56 in each block 72(l). For a thirty two track arrangement, in order to be able to generate sufficient unique data unit designations for a data set divided into ten data unit groups, 13 bits may be allowed for a data unit designation 56 in order to be able to generate sufficient unique data unit designations. For thirty one data units 34 in a thirty two track rewrite data unit group that provides a requirement of 31×13 bits (51 bytes) for a list containing the data unit designation of each of the thirty one data units. The 960 bytes designated for blocks 72 of the respective track portions 0-31 are divided into thirty two 30 byte blocks. Thus, one block 72 does not have the capacity for an identifier information unit containing a complete list of the thirty one data unit designations 56. The list may be split to form lists containing fifteen of the data unit designations and a list containing sixteen of the data unit designations and the two lists written into respective identifier information units that can be put into separate blocks 72(l). In one example, a block 72(l) containing an information identifier unit containing a list of fifteen data unit designations may be provided in data track portion 0 and each of the even numbered data track portions and a block 72(l) containing an identifier information unit containing a list of the other sixteen data unit designations may be provided in each of the odd numbered track portions. In another example, a rewrite data unit group with thirty two track portions may be divided into two sub-groups that each have sixteen track portions and use a sixteen data track configuration such as those shown in FIGS. 6 to 8.

Although not shown in the illustrated examples, the data unit groups may be provided with error correction C1, C2 (ECC) parity coding. The use of ECC coding is known to those skilled in the art and will not be described in detail herein.

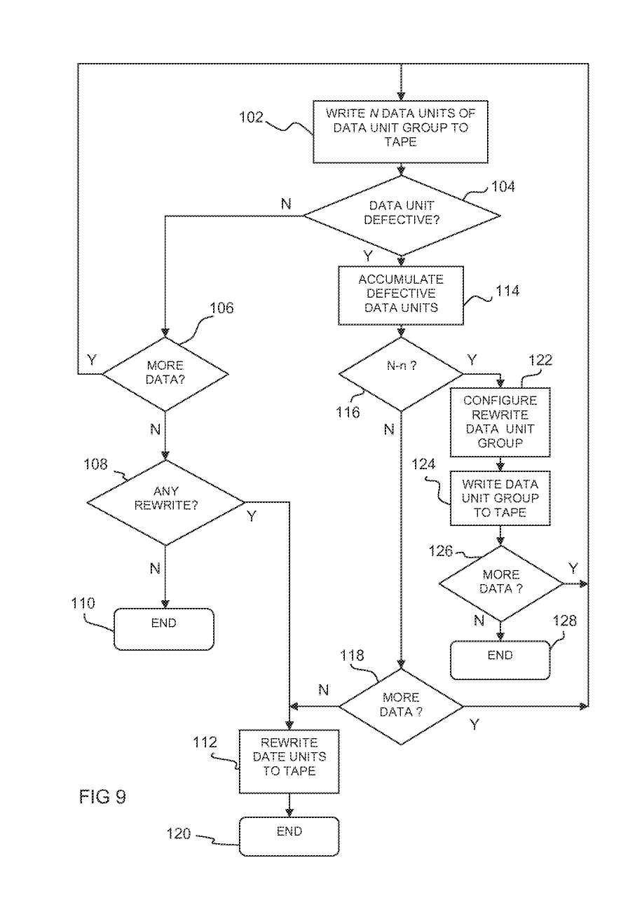

Referring to FIG. 9, in an example of a method of writing data to a tape, during a write operation, at 102 tape drive 10 writes a data unit group 32 that comprises N data units written across tape 16 as N track portions 0-15 that are a part of N tracks that extend in a lengthways direction of tape 16. At 104, tape drive checks for data units written in the data unit group 32 that are defective and need to be rewritten. If there are none, at 106 tape drive 10 checks to see if there is more new data to be written. If yes, the process returns to 102. If no, at 108 tape drive checks to see if there are any data units identified as needing to be rewritten. If no, the write operation stops at 110. If yes, the data units are written to tape 16 at 112 and the write operation may stop at 120.

If at 104 tape drive 10 identifies one or more data units written at 102 that need to be rewritten, the data unit(s) are accumulated at 114 for rewriting in a rewrite data unit group 40. At 116 tape drive checks to determine whether the total number of accumulated data units equals the desired N-n value (fifteen in the examples illustrated by FIGS. 6 to 8). If no, at 118 tape drive checks to see whether there is more new data to be written. If yes, tape drive returns to 102. If no, at 112 tape drive the rewrites the accumulated data units at 112 and the write operation ends at 120.

If at 116 it is determined that there are the desired number N-n of data units needing to be rewritten, at 122 tape drive configures a rewrite data unit group 40, for example a rewrite data unit group as shown in FIG. 6, 7 or 8, and at 122 tape drive writes the rewrite data unit group to tape 16. Following the writing of the rewrite data unit group, at 126 tape drive checks to see if there is new data to be written to tape 16. If there is new data to be written, the tape drive returns to 102 and if there in none, the write operation ends at 128.

In FIG. 9 at 106, 108 and 118 it may be determined that there is no more new data to be written and there are insufficient data units identified as needing to be rewritten to fill a rewrite data unit group. Nonetheless, it is still possible to configure a rewrite data group containing the data units needing to be written and at least one identifier information unit containing a list or respective lists of data unit designations for the data units in the rewrite data group.

In examples of a method of writing data to a tape, a rewrite data unit group is configured to be written across data tracks that extend in a lengthways direction of a tape. The rewrite data group is configured to be written to be written as a plurality N of data track portions. A data unit group consisting of newly written data, typically contains a number N of data units corresponding to the number of data track portions with one data unit assigned to each track portion. A rewrite data unit group has a number N-n of data units that is less than the number of track portions. Except for a group written at the end of a write operation when there may not be sufficient data units identified as needing to be rewritten, the number n may be 1. The reduced number of data units in the rewrite data unit group creates space for data unit identifier information and by restricting this space to only one track portion, a rewrite data unit group still makes efficient use of the track space assigned to the group. Thus examples of such a method of writing data to a tape provide more efficient usage of track space than methods in which an entire data unit group containing a data unit that needs to be rewritten is rewritten to the tape while at the same time providing protection against data loss just as the use of cross channel interpolation provides protection for data unit groups consisting of newly written data units.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method of writing data to a tape on which during a write operation successive data unit groups that each comprise a plurality N of data units are written across the tape in N track portions to form N data tracks that extend in a lengthways direction of the tape, the method comprising:
identifying data units written during the write operation that need to be rewritten; and
writing a rewrite data unit group that comprises N track portions written across the tape to form a part of the N data tracks,
wherein the N track portions of the rewrite data unit group contain N-n data units identified as needing to be rewritten, where n is a positive integer value, and data unit identifier information comprising respective data unit identifiers for the N-n data units, and
wherein the data unit identifier information is written in at least one identifier information unit that contains a list of data unit identifiers.

2. A method of writing data to a tape as claimed in claim 1, wherein n equals 1.

3. A method of writing data to a tape as claimed in claim 1, wherein there is at least one identifier information unit that contains a list of the respective data unit identifiers of each of the N-n data units in the rewrite data unit group.

4. A method of writing data to a tape as claimed in claim 3, wherein the list comprises at least two copies of each data unit identifier.

5. A method of writing data to a tape as claimed in claim 1, wherein the data units each comprise a header that contains a data unit designation for the data unit and a data portion and the data unit identifiers comprise the respective data unit designations of the N-n data units.

6. A method of writing data to a tape as claimed in claim 5, wherein the N track portions of the rewrite data unit group each have a header block to receive a data unit header and N data blocks and one data block of each track portion contains a said identifier information unit.

7. A method of writing data to a tape as claimed in claim 6, wherein at least two of the data blocks containing a said identifier information unit are located at different longitudinal locations in the respective data track portions.

8. A method of writing data to a tape as claimed in claim 6, wherein at least two of the data blocks containing a said identifier information unit are located at the same longitudinal location in the respective data track portions.

9. A method of writing data to a tape as claimed in claim 1, wherein read-while-write is used in identifying data units that need to be rewritten.

10. A tape drive comprising:
a plurality N of write heads to write successive data unit groups that each comprise a plurality N of data units written across a tape as N data track portions to form N data tracks that extend in a lengthways direction of the tape;
a plurality N of read heads to read the data tracks written by the write heads; and
logic coupled with the write heads and read heads and configured to identify data units that need to be rewritten,
the logic configured to cause an accumulation of data units that need to be rewritten to be written to the tape in a rewrite data unit group that comprises N data track portions written across the tape to form a part of the N data tracks,
wherein the N data track portions of the rewrite data unit group contain N-n accumulated data units, where n is a positive integer, and data unit identifier information comprising respective data unit identifiers for the N-n data units of the rewrite data unit group, and
wherein the data unit identification information is written in at least one identifier information unit that contains a list of data unit identifiers.

11. A tape drive as claimed in claim 10, wherein the write heads and read heads are mounted in a read/write head configured so that read-while-write information is provided to the logic for identifying data units that need to be rewritten.

12. A tape drive as claimed in claim 10, wherein there is at least one identifier information unit that contains a list containing at least one instance of the respective data unit identifiers of each of the N-n data units in the rewrite data unit group.

13. A tape drive as claimed in claim 10, wherein the logic causes at least two of the track portions to be provided with a said identifier information unit, the identifier information units provided at different longitudinal positions in the respective track portions.

14. A tape drive as claimed in claim 10, wherein;
each data unit comprises a header that contains a data unit designation for the data unit and a data portion and the data unit identifiers comprise the respective data unit designations of the N-n data units,
each of the N-n track portions is assigned a space to receive a header and a space to receive data from the data unit data portions, and
the at least one identifier information unit is provided in a said space to receive data.

15. An article comprising a computer readable storage medium storing instructions that when executed by at least one processor cause the at least one processor to:
identify data units that have been written to a tape that need to be rewritten, the data units being written in data unit groups comprising a plurality N of data units written across the tape in respective track portions of N data tracks that extend in a lengthways direction of the tape; and
configure a rewrite data unit group containing N-n data units identified as needing to be rewritten, where n is a positive integer, and data unit identifier information comprising respective data unit identifiers for the N-n data units, the data unit identification information contained in at least one list of data unit identifiers.
